(19) United States
(12) Patent Application Publication
(10) Pub. No.: US 2008/0104632 A1
(43) Pub. Date: May 1, 2008

(54) METHOD OF CONTROLLING REPRODUCTION IN BROADCAST RECORDING DEVICE

(75) Inventor: Young Sang KWON, Pyeongtaek-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/923,382

(22) Filed: Oct. 24, 2007

(30) Foreign Application Priority Data
Oct. 25, 2006 (KR) 10-2006-0103892

(51) Int. Cl. H04N 7/10

(52) U.S. Cl. 725/32

(57) ABSTRACT

A method of controlling reproduction in a broadcast recording device, is discussed. According to an embodiment, the method includes when there is a request for reproduction of a title, determining if an outputting of advertisement associated with the title is required for the reproduction of the title; selectively outputting the advertisement based on the determination result; and reproducing the title, after the outputting of the advertisement has been completed.

This application claims the priority benefit of Korean Patent Application No. 10-2006-103892, filed on Oct. 25, 2006, which is hereby incorporated by reference as if fully set forth herein.

### BACKGROUND OF THE INVENTION

1. Field of the Invention

The present invention relates generally to a method of controlling reproduction in a broadcast recording device, and more particularly, to a broadcast recording/reproducing device and a method of controlling reproduction in a broadcast recording/reproducing device, which require a user to view an advertisement when a broadcast program recorded in the broadcast recording device is reproduced.

2. Description of the Related Art

In general, advertisement is an information or activity that is provided or performed by a company, an individual, or an organization so as to make a product or service publicly known and then achieve a desired purpose. For example, audio-visual media, such as text, images, or sounds, are used for the advertisement. Advertisement can include an advertiser's non-personal paid provision of information about an idea, a product, or a service, or an advertiser's paid promotion of an idea, a product, or service.

Advertisement can be a non-personal paid communication that is made by a company, a nonprofit organization or an individual, which is conveyed in an advertising message in some form, via various media. In particular, an informative commercial broadcast via commercial broadcasting, that is, a commercial statement containing advertising content, is referred to as a “Commercial Message (CM).”

Commercial Messages (CMs) are classified into two types: program commercials inserted into broadcast programs, and spot announcements provided between programs.

Meanwhile, optical disk devices, such as a Digital Versatile Disk (DVD) recorder, which are capable of recording high-image quality video data and high-audio quality audio data on an optical disk, have been developed and commercialized. Furthermore, various types of broadcast recording devices, in which set-top boxes are integrated with hard disk recorders, and which are capable of receiving broadcast programs and recording them on hard disks, have been commercialized.

Accordingly, a user can select a desired broadcast program, record the broadcast program on a DVD inserted into a DVD recorder or on a hard disk included in a hard disk recorder, and then view the stored broadcast program at a desired time.

A CM is included in a broadcast program recorded in such a broadcast recording device, and is provided along with the broadcast program. Such CMs are a main source of income for the broadcasting stations that produce broadcast programs. Broadcasting stations invest such advertising revenues in the production costs of the broadcast programs.

Meanwhile, Content Providers (CPs), providing various types of content over the Internet, include advertisements in various types of content, and provide the content, including the advertisements, to many unspecified Internet users without charge.

However, when a user views various types of titles on a recording medium after storing them, there may be cases where the user edits CMs included in the titles and views only the titles. Accordingly, advertisements, which are provided by the broadcasting stations or content providers that provide the corresponding titles, are not viewed and are skipped by the user. In such a case, a problem arises in that the benefits of including the advertisements are not realized and the advertisements become a waste of various resources.

### SUMMARY OF THE INVENTION

Accordingly, the present invention has been made keeping in mind the above and other problems and limitations associated with the related art, and an object of the present invention is to provide a broadcast recording device and a method of controlling reproduction in a broadcast recording device, which require a user to view an advertisement when a broadcast program recorded in the broadcast recording device is reproduced.

In order to accomplish the above and other objects, the present invention provides according to an embodiment a method of controlling reproduction in a broadcast recording device, comprising the steps of reproducing at least one advertisement when there is a request for reproduction of a title, including information related to viewing of advertisement, among broadcast titles stored in a medium; and reproducing the title, the reproduction of which is requested, after the reproduction of the advertisement has been completed.

In addition, the present invention provides according to an embodiment a broadcast recording device, comprising a broadcast receiver for selecting a broadcast channel and receiving broadcast signals; a recording unit for recording the broadcast signals on a medium; a signal processor for decoding the broadcast signals from the broadcast receiver or the broadcast signals read from the medium and outputting audio/video signals; and a controller for, if there is a request for reproduction of a title including information related to viewing of advertisement among broadcast titles stored on the medium, controlling the recording unit and the signal processor so as to reproduce at least one advertisement and reproduce the title, the reproduction of which is requested, after the reproduction of the advertisement has been completed.

In an embodiment of the present invention, the data of the advertisement may be recorded on the medium along with the title.

In an embodiment of the present invention, the data of the advertisement may be transmitted from an external server related to the title, and the information related to viewing of advertisement may include link information for connection to the external server. The transmitted advertisement data may be an advertisement that is designated for the title or is changed in real time by the external server. The external server may control the transmission speed of the advertisement data.

In an embodiment of the present invention, the external server may provide a menu screen so that a user can select a desired type of advertisement. The number of advertisements and/or the duration of each advertisement to be viewed may be determined differently according to the selected type of advertisement, and an additional service related to the title may be provided according to the selected type of advertisement, a time period of viewing of an advertisement or advertisements, or the number of repeated views of an identical advertisement.

In an embodiment of the present invention, the information related to viewing of advertisement may include the number of views of advertisement, and the advertisement is reproduced before the reproduction of the title, the reproduction of which is requested, if the number of views of advertisement is less than a predetermined number. After the reproduction of the advertisement has been completed11, the number of views of advertisement is updated.

In an embodiment of the present invention, a user's command related to trick play may be disregarded while the advertisement is reproduced.

In an embodiment of the present invention, the title may be recorded on the medium in an encrypted state, and may be decrypted and reproduced using an encryption key generated when the reproduction of the advertisement is completed. The encryption key may be distributed in the advertisement data. Alternatively, the title may be encrypted and recorded using different encryption keys for respective sections of the title, and the encryption keys for the respective sections may be separately stored in multiple pieces of advertisement data.

According to an embodiment, the present invention provides a method of controlling reproduction in a broadcast recording device, comprising: when there is a request for reproduction of a title, determining if an outputting of advertisement associated with the title is required for the reproduction of the title; selectively outputting the advertisement based on the determination result; and reproducing the title, after the outputting of the advertisement has been completed.

According to another embodiment, the present invention provides a broadcast device comprising: a broadcast receiver configured to select a broadcast channel and to receive broadcast signals; a recording unit configured to record the broadcast signals on a medium; a signal processor configured to decode the broadcast signals from the broadcast receiver or the broadcast signals read from the medium, and to output audio/video signals; and a controller configured to control the recording unit and the signal processor, wherein if there is a request for reproduction of a title, the controller determines if an outputting of advertisement associated with the title is required for the reproduction of the title, selectively outputs the advertisement based on the determination result, and reproduces the title after the outputting of the advertisement has been completed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the construction of a broadcast recording device according to an embodiment of the present invention;

FIG. 2 is a flowchart illustrating a method of controlling reproduction in a broadcast recording device according to an embodiment of the present invention;

FIG. 3 is a diagram illustrating an example in which a title is recorded on a storage medium according to an embodiment of the present invention; and

FIG. 4 is a diagram illustrating another example in which a title is recorded on a storage medium according to an embodiment of the present invention.

### DETAILED DESCRIPTION OF PREFERRED EMBODIMENTS

Reference now should be made to the drawings, in which the same reference numerals are used throughout the different drawings to designate the same or similar components.

Preferred embodiments of a method of controlling reproduction in a broadcast recording device according to the present invention will be described with reference to the accompanying drawings below.

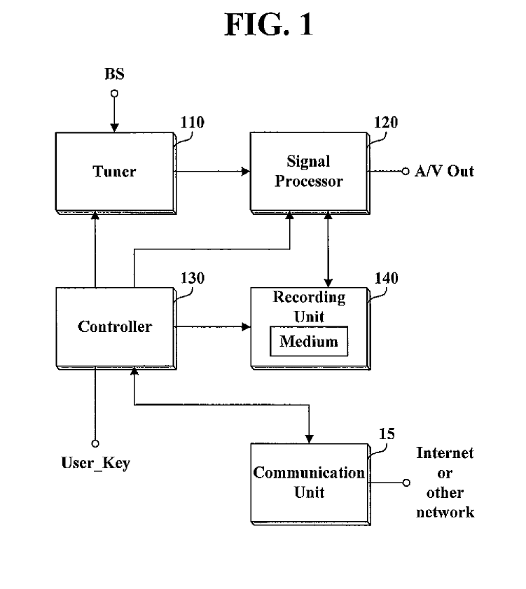

FIG. 1 is a block diagram schematically showing the construction of a broadcast recording device according to an embodiment of the present invention. The present invention is applicable to various types of broadcast recording devices in which broadcast reception units are integrated with recording/reproduction units. That is, the broadcast recording device of the present invention is capable of both recording and reproducing to and from various storage mediums, and thus can include a recording unit and a reproducing unit.

The broadcast recording device according to the present invention, as shown in FIG. 1, includes a tuner 110, a signal processor 120, a controller 130, and a recording unit 140. The present invention may further include a communication unit 15 depending on the embodiment. An optical disk, a hard disk, or flash memory can be used as a storage medium of the recording unit 140. Here the storage medium of the recording unit 140 can be part of the broadcast recording device such as a hard drive or can be a removable storage medium. The broadcast recording device can include other components, and all components of the broadcast recording device are operatively coupled and configured.

The tuner 110 is used to tune and select a broadcast channel requested by a user and to receive broadcast signals provided through the selected broadcast channel. The signal processor 120 separates audio and video signals from the broadcast signals, decrypts the separated audio and video signals into original audio and video signals, and outputs the original audio and video signals to an output device such as a television (TV) set or a display unit. The display unit can be part of the broadcast recording device or can be an external device.

The controller 130 controls the tuner 110 and the signal processor 120, thereby performing a broadcast reception operation of receiving and outputting a broadcast through a TV set (or a display unit). When the recording of a broadcast program is requested by a user, the controller 130 controls the recording unit 140, thereby performing an operation of recording the received broadcast signals in a storage medium such as an optical disk or a hard disk.

Furthermore, the controller 130 controls the signal processor 120 and the recording unit 140, thereby performing an operation of reproducing a title, for example, a broadcast program, that was stored in the storage medium of the recording unit 140. Here, although a reproduction of a broadcast program or other broadcasts is requested in reference to the title of the broadcast program or broadcasts, this is merely an example, and other means to identify or refer to the desired broadcast can be used.

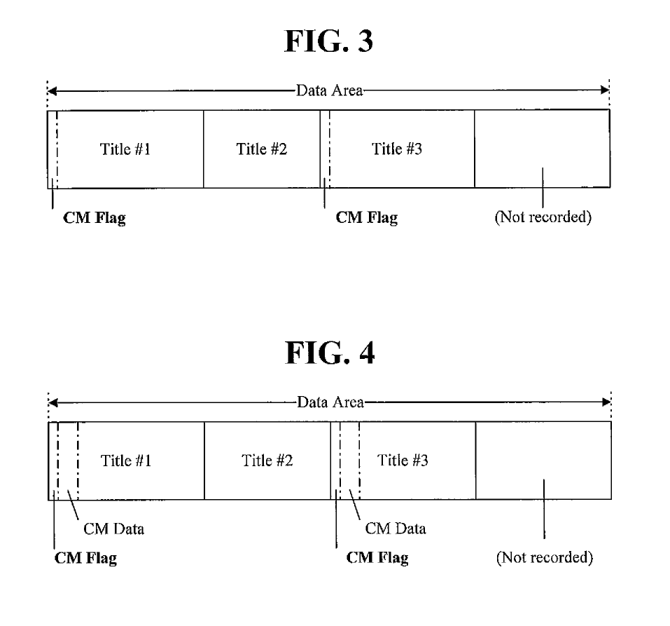

The controller 130 checks whether information related to compulsory advertisement viewing, for example, CM flag information, is present in a title which has been requested to be reproduced. For example, FIG. 3 shows a title having CM flag information. If the CM flag information is present, the controller 130 temporarily stops the operation of reproducing the title, controls the communication unit 150 so as to request CM transmission from a CM server (not shown) of a broadcasting station connected through a network such as the Internet, and controls the signal processor 120 (or other reproducing unit) so as to decrypt the transmitted CM data and output the transmitted CM data through the screen and speaker of the TV set or other connected output unit. Here, the CM transmitted through the network may be a CM that is designated previously for the title or is changed or updated in real time.

When the reproduction of the transmitted CM is completed, the controller 130 reproduces the corresponding title, increases the number of viewings of the CM (e.g., by one) for the corresponding title, and updates the CM flag information accordingly (e.g., by storing the increased number of viewings in the CM flag information).

Meanwhile, when the controller 130 checks whether a CM flag is present in the title to be reproduced, the controller 130 directly reproduces the title if the title has no CM flag or if the number of viewings of the CM for the title exceeds a reference value, for example, 5. That is, if a title has no CM flag (which means the title/program can be viewed without requiring the viewing of the associated CM) or if a title has the number of viewings of the CM that exceeds a preset number (which means the associated CM has been viewed at least the desired number of times), then the title can be reproduced without requiring the associated CM to be output again.

The CM flag information is included in broadcast signals, and is recorded on a storage medium along with a broadcast program for each broadcast program. In this case, the broadcast program can be recorded and the recorded broadcast program may be viewed only after the associated CM (e.g., an advertisement) has been viewed.

The number of viewings of CMs is recorded in the CM flag information, and is updated according to the viewings of CMs. After a user has viewed CM data (CM) more than a reference number of times, compulsory CM viewing requirement can be lifted or removed based on the updated number of viewings of CMs. Furthermore, the CM flag information can include information about the address of a CM server to be accessed in order to download the CM data, e.g., link information (e.g., IP address, etc.) used to connect to the CM server. For instance, the CM flag information can include CM server information, and the controller 130 can access a CM server using the CM server information to obtain and reproduce the CM data. In another example, a title may include CM flag information as well as CM data as shown in FIG. 4. In such a case, the CM data can be obtained directly from the title for reproduction.

Moreover, the CM flag information may include one or more encryption keys which can also function as a decryption key. A corresponding broadcast program can be encrypted using an encryption key and can be then recorded on the storage medium, while the recorded broadcast program can be decrypted using an encryption key generated when the reproduction of the CM data is completed, and is then reproduced. For this purpose, the authenticated recording unit 140 extracts an encryption key from the CM flag information, included in a broadcast program and transmitted along with the broadcast program, encrypts the broadcast program using the encryption key, and records the broadcast program with the CM flag information in the storage medium. In this case, the CM flag information recorded with the broadcast program in the storage medium can include the encryption key or exclude the encryption key.

According to an embodiment, the encryption key is distributed and stored in the CM data (the CM itself). Therefore a complete encryption key can be generated only when the reproduction of the CM data is completed. Alternatively, the encryption key may be distributed among multiple pieces of CM data and then be stored in the multiple pieces of CM data, in which case the encryption key can be generated only after a user has viewed all of the multiple pieces of CM data.

Alternatively, when a broadcast program is encrypted and recorded, different encryption keys are used for respective sections of the broadcast program, and the encryption keys for the respective sections are separately stored in multiple pieces of CM data. In this case, only the sections of the broadcast program corresponding to viewed CM data can be reproduced. When a user desires to reproduce the remaining sections of the broadcast program, the user must view the remaining CM data in order to generate encryption keys for the remaining sections.

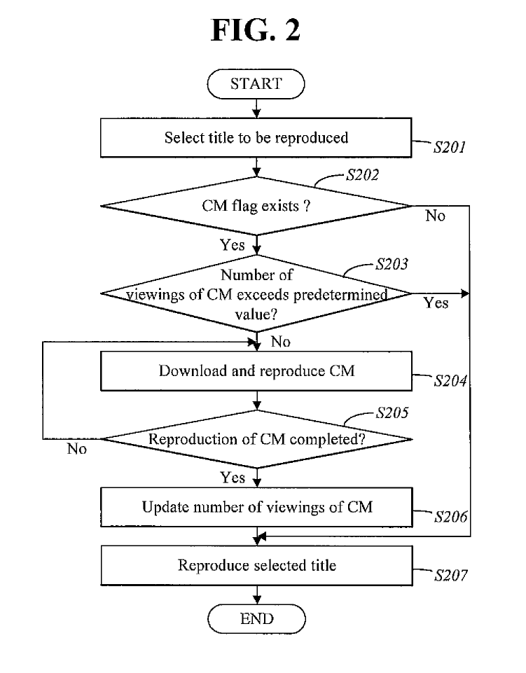

The operation of the method of controlling reproduction of broadcast content according to an embodiment of the present invention is described in detail below with reference to the accompanying FIGS. 2 to 4.

FIG. 2 is a flowchart illustrating the method of controlling reproduction in a broadcast recording device according to an embodiment of the present invention. FIG. 3 is a diagram illustrating an example in which a title is recorded on a storage medium. The method of FIG. 2 is implemented by the broadcast recording device of FIG. 1, but can be implemented by other recording/reproducing apparatus or other suitable device.

Referring to FIG. 2, when a user requests the reproduction of a title stored in the storage medium of the recording unit 140 at step S201, the controller 130 checks whether CM flag information is present in the title which has been requested to be reproduced, as shown in FIG. 3, at step S202. Here, although a reproduction of a title from the storage medium is requested, the invention is not limited thereto and can apply to a reproduction of any program or information, which may not be stored in the storage medium but may be accessible from an external source or which may be received wirelessly in real time such as a DMB signal. If, as a result of the checking at step S202, the CM flag information is found to be present in the title, the controller 130 checks whether the number of viewings of CM, included in the CM flag information, exceeds a reference value, for example, five, in the state in which the reproduction of the title is temporarily stopped at step S203.

When the number of viewings of CM, included in the CM flag information, is less than the reference number, for example, five, the controller 130 controls the communication unit 140 so as to download the CM data (CM) from a CM server of a broadcasting station or a CP connected over a network such as the Internet, and controls the signal processor 120 so as to decode and reproduce the downloaded CM data at step S204. At step S204, the reproduced CM (CM data) is output to the associated output unit such as a TV set, a display unit, speakers, etc.

Trick play may not be permitted on CM data, so that a CM can be effectively and completely viewed without skipping. For this purpose, the CM server (or the like) may control the download speed of the CM data, or the controller 130 may disregard the user's input related to such trick play at the time of reproducing the CM.

Here, the CM (i.e., CM data) transmitted from the CM server (or from another source) may be a CM that is pre-designated for the corresponding title or is changed/updated in real time by the broadcasting station or the CP.

After all of the downloaded CM data for the requested title has been reproduced at step S205, the controller 130 increases or decreases the number of reproductions of CM(s) and then updates the CM flag information accordingly at step S206, and performs a reproduction operation on the title at step S207. For instance, at step S207, once the CM data associated with the requested title has been output to the user, the controller 130 increases the number of viewings of the CM data by one, and this updated viewing number is stored in the CM flag information.

On the other hand, if the CM flag information does not exist in the title at step S202, or the number of viewings of CM(s), set in the title, exceeds a set value, for example, five, at step S203, the controller 130 omits the operations of downloading and reproducing the CM, and directly performs a reproduction operation on the corresponding title at step S207.

Meanwhile, when the CM data is downloaded from the CM server, a menu screen that allows a user to select a desired type of CM may be provided, e.g., on the associated display unit or the TV set. The CM server may classify CMs into various types according to gender, age, vocation, etc., and allow the user to select one from them to as to provide more targeted advertising. As an example, CMs related to electric/electronic products, cars, and sports equipment, which generally more male viewers may like, or CMs related to cosmetics, clothes, foods, or houses, which generally more female viewers may like, may be prepared, and a selection menu screen containing these categories can be transmitted to the broadcast recording device so that a user can select it according to the user's preference. In another example, if the broadcast recording device has an interactive capability, the broadcast recording device can collect a user's viewing habits, preferences and other information, and can automatically provide CMs that are more targeted to the user based on the user's viewing habits, preferences and other information.

Furthermore, according to the type of CM that is selected by a user, the number of CMs and/or the duration of a CM or CMs that the user is asked to view may be changed. As an example, a user may be required to view many CMs preferred by users and configured to contain brilliant images and music, while the user may be required to view few tedious CMs, such as CMs related to insurance goods or service goods.

When a CM is repeatedly viewed, the imprinting effect of the advertisement is high, so that the number of CMs or the duration of a CM or CMs to be viewed by the user may be reduced, or a wide range of selections associated with the type of CM, the number of CMs, the duration of a CM or CMs, and/or the number of viewings of the same CM may be offered to a user.

Moreover, according to the type of CM that is selected by a user, the time period during which a user views a CM or CMs, or the number of repeated viewings of the same advertisement, an additional service, for example, the provision of subtitles in various languages, the provision of different dubbing languages, or the provision of meta data about a broadcast program may be offered.

In another embodiment of the present invention, as mentioned above when a broadcast program title including CM flag information is recorded on a storage medium, CM data associated with the title is recorded along with the title, as shown in FIG. 4. In this case, when the title recorded on the storage medium is reproduced, an operation of downloading CM data from an external source at step S204 of FIG. 2 is omitted and the CM data recorded on the storage medium is reproduced directly.

When recording a broadcast program including CM flag information on the storage medium, the controller 130 may provide a selection menu so that a user can select whether to record CM data along with the broadcast program or whether to download CM data later.

As described above, the present invention has the advantages of requiring a user to view a CM or CMs set in a title or program by using CM flag information. Further, the present invention monitors the number of viewings of an associated CM when a reproduction of a program is requested, and effectively controls the reproduction of the CM based on this information. Furthermore, encryption/decryption keys for decrypting encrypted broadcast programs for reproduction may be stored in CM flag information and/or CM data, and can be used to ensure that the CM is outputted to the user before the broadcast program can be reproduced. Moreover, more targeted advertisement can be provided to the user. In addition, CM data can be stored along with the title (e.g., program) and the CM flag information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling reproduction in a broadcast recording device, comprising:
when there is a request for reproduction of a title, determining if an outputting of advertisement associated with the title is required for the reproduction of the title;
selectively outputting the advertisement based on the determination result; and
reproducing the title, after the outputting of the advertisement has been completed.

2. The method as set forth in claim 1, wherein the determining step includes:
checking the title to detect a presence of CM (commercial message) flag information; and
examining CM viewing information of the CM flag information if the CM flag information is present in the title.

3. The method as set forth in claim 2, wherein the determining step determines that the outputting of the advertisement is required for the reproduction of the title, if the CM viewing information indicates that the number of the outputtings of the advertisement is less than a preset number.

4. The method as set forth in claim 2, wherein the determining step determines that the outputting of the advertisement is not required for the reproduction of the title, (a) if the CM flag information is not present in the title or (b) if the CM viewing information indicates that the number of the outputtings of the advertisement is equal to or great than a preset number.

5. The method as set forth in claim 1, wherein at least one of data of the advertisement and viewing information of the advertisement is recorded on a medium along with the title, and the determining step is performed using the viewing information.

6. The method as set forth in claim 1, wherein the determining step is performed using viewing information of the advertisement, and data of the advertisement is transmitted from an external server related to the title.

7. The method as set forth in claim 6, wherein the viewing information includes link information for connecting to the external server.

8. The method as set forth in claim 6, wherein the external server controls a transmission speed of the advertisement data.

9. The method as set forth in claim 6, wherein the advertisement data transmitted from the external server is an advertisement that is pre-designated for the title or is updated in real time by the external server.

10. The method as set forth in claim 6, wherein the external server provides a menu screen for allowing a user to select a desired type of advertisement.

11. The method as set forth in claim 10, wherein a number of advertisements and/or a duration of each advertisement to be viewed is determined differently according to the selected type of advertisement.

12. The method as set forth in claim 10, wherein an additional service related to the title is provided according to at least one of the following: the selected type of advertisement, a time period of viewing of advertisement or advertisements, or a number of repeated viewings of an identical advertisement.

13. The method as set forth in claim 1, wherein the determining step examines the number of viewings of the advertisement, and the outputting step outputs the advertisement if the number of viewings of the advertisement is less than a predetermined number and updates the number of viewings of the advertisement after the outputting of the advertisement has been completed.

14. The method as set forth in claim 1, wherein a user's command related to trick play is disregarded while the advertisement is output.

15. The method as set forth in claim 1, wherein the title is recorded on a medium in an encrypted state, and is decrypted and reproduced using an encryption key generated when the reproduction of the advertisement is completed.

16. The method as set forth in claim 15, wherein the encryption key is distributed through data of the advertisement.

17. The method as set forth in claim 1, wherein the title is encrypted and recorded using different encryption keys for respective sections of the title, and the encryption keys for the respective sections are separately stored in multiple pieces of data of the advertisement.

18. A broadcast device comprising:
a broadcast receiver configured to select a broadcast channel and to receive broadcast signals;
a recording unit configured to record the broadcast signals on a medium;
a signal processor configured to decode the broadcast signals from the broadcast receiver or the broadcast signals read from the medium, and to output audio/video signals; and
a controller configured to control the recording unit and the signal processor,
wherein if there is a request for reproduction of a title, the controller determines if an outputting of advertisement associated with the title is required for the reproduction of the title, selectively outputs the advertisement based on the determination result, and reproduces the title after the outputting of the advertisement has been completed.

19. The broadcast device as set forth in claim 18, wherein the controller checks the title to detect a presence of CM (commercial message) flag information, and examines CM viewing information of the CM flag information if the CM flag information is present in the title.

20. The broadcast device as set forth in claim 19, wherein the controller determines that the outputting of the advertisement is required for the reproduction of the title, if the CM viewing information indicates that the number of the outputtings of the advertisement is less than a preset number.

21. The broadcast device as set forth in claim 19, wherein the controller determines that the outputting of the advertisement is not required for the reproduction of the title, (a) if the CM flag information is not present in the title or (b) if the CM viewing information indicates that the number of the outputtings of the advertisement is equal to or great than a preset number.

22. The broadcast device as set forth in claim 18, further comprising:
a communication unit configured to receiving data of the advertisement from an external server,
wherein the controller controls the communication unit so as to be connected to the external server for exchanging data according to link information included in viewing information related to a viewing of the advertisement, and
wherein the controller determines if the outputting of advertisement is required for the reproduction of the title by using the viewing information.

23. The broadcast device as set forth in claim 18, wherein the controller disregards a user's command related to trick play while the advertisement is output.

24. The broadcast device as set forth in claim 18, wherein an encryption key, which is used to decrypt and reproduce the title, is stored with viewing information of the advertisement or is distributed through data of the advertisement.

25. The broadcast device as set forth in claim 18, wherein the controller examines the number of viewings of the advertisement, outputs the advertisement if the number of viewings of the advertisement is less than a predetermined number, and updates the number of viewings of the advertisement after the outputting of the advertisement has been completed.
